(19) United States
(12) Patent Application Publication
(10) Pub. No.: US 2009/0249205 A1
(43) Pub. Date: Oct. 1, 2009

(54) DISPLAY POSITION DETERMINATION APPARATUS AND METHOD THEREOF

(75) Inventors: Ryusuke Yoshimura, Kawasaki (JP); Kasumi Miura, Kawasaki (JP); Yoshiaki Yamamoto, Kawasaki (JP); Dai Miyawaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/366,382

(22) Filed: Feb. 5, 2009

(30) Foreign Application Priority Data
Mar. 27, 2008 (JP) 2008-083923

(51) Int. Cl. G06F 3/048

(52) U.S. Cl. 715/715

(57) ABSTRACT

A display position determination apparatus has a selection unit selecting a first part from a parts group of display objects, an acquisition unit acquiring display occupancy in a display screen for each of said display objects, a judgment unit judging whether a balloon for the first part selected by said selection unit can be displayed within a non-display area or not in said display screen where no parts group is displayed; a search unit searching a second part from said parts group based on the display occupancy acquired by said acquisition unit when said judgment unit judges that the balloon cannot be displayed in said non-display area, and a determination unit determining that the display area of the balloon for said first part is within the display area of the second part searched by said search unit.

### CROSS-REFERENCE TO RELATED APPLICATION

This application is based upon and claims the benefit of priority of Japanese Patent Application No. 2008-83923, Filed on Mar. 27, 2008, the entire contents of which are incorporated herein by reference.

### FIELD

The embodiment discussed herein is directed to a display position determination apparatus to display a balloon having an annotation such as a part name and a part ID of a display object and method thereof.

### BACKGROUND

Recently applications are provided to assist a user's operation by displaying an object such as a precision machine on a screen. Such applications allow the object to be enlarged, reduced and rotated on a screen.

Moreover, a technique has been developed to display a balloon that shows an annotation such as a part name and a part ID of each of the parts in the display object on the screen.

### SUMMARY

A display position determination apparatus which has a selection unit selecting a first part from a group of parts that display objects, an acquisition unit acquiring display occupancy for a display screen for each of the parts, a judgment unit judging whether a balloon related to the first part selected by the selection unit can be displayed within a non-display area in the display screen where no parts in the group is displayed; a search unit searching a second part from the parts group based on the display occupancy acquired by the acquisition unit when the judgment unit judges that the balloon cannot be displayed in the non-display area, and a determination unit determining whether the display area of the balloon for the first part is within the display area of the second part searched by the search unit.

Additional objects and advantages of the embodiment will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is an explanatory diagram illustrating conventional drawbacks in display systems;

FIG. 2 is a block diagram illustrating a hardware configuration of a display position determination apparatus;

FIG. 3 is an explanatory diagram illustrating an example of a display screen (1 of 3);

FIG. 4 is an explanatory diagram illustrating an example of a stored content of a part information table (1 of 3);

FIG. 5 is a block diagram illustrating a functional configuration of a display position determination apparatus;

FIG. 6 is an explanatory diagram illustrating an example of a stored content of a part information table (2 of 3);

FIG. 7 is an explanatory diagram illustrating an example of a display screen (2 of 3);

FIG. 8 is an explanatory diagram illustrating an example of a stored content of a part information table (3 of 3);

FIG. 9 is an explanatory diagram illustrating an example of a display screen (3 of 3);

FIG. 10A is a flowchart illustrating an example of processing procedures of the display position determination apparatus to determine a display position (1 of 2); and

FIG. 10B is a flowchart illustrating an example of processing procedures of the display position determination apparatus to determine a display position (2 of 2).

### DESCRIPTION OF EMBODIMENT

Preferred embodiments of a display position determination apparatus and method thereof are explained in detail by referring to the accompanying drawings.

According to this embodiment, a position to display a balloon showing an annotation of a display object (e.g., a part name and a part ID) is appropriately determined. More specifically a method is proposed in which a balloon is appropriately displayed even when there is not enough free space on the screen as a result of input such as enlarging or rotating a display object.

In this embodiment, an example is explained in which machine part data created by software to assist design such as a computer aided design (CAD) is displayed on a screen of the display position determination apparatus.

### <Overview>

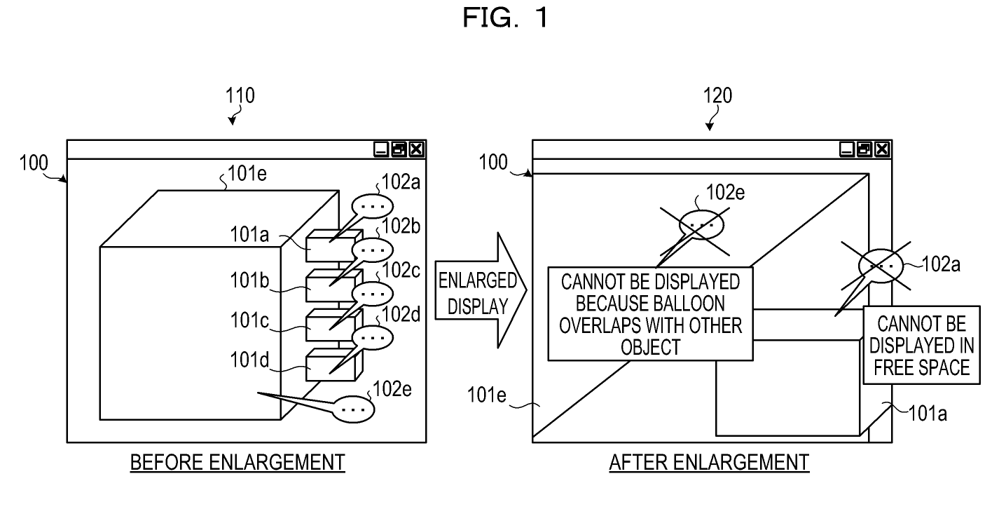

First, an overview of an embodiment is explained. FIG. 1 is an explanatory diagram illustrating conventional drawbacks of display systems. In FIG. 1, the display screen 100 displays an example of a screen display before enlargement 100, and an example of screen display after enlargement 120. The example of screen display before enlargement 110 displays display objects, parts 101a to 101e and balloons 102a to 102e for the parts 101a to 101e, respectively, on the display screen 100.

In the example of screen display after enlargement 120, the parts 101a and 101e are partially displayed on the display screen 100. The balloon 102a for the part 101a and the balloon 102e for the part 101e are not displayed. Conventional balloon display technology controls a balloon so that the balloon is not displayed when the balloon overlaps with another display object.

As a result of the enlargement, free space in the display screen 100 is reduced. Thus, the balloon 102a and the balloon 102e are not displayed because the balloons are overlapped with the part 101a and the part 101e if the balloons are displayed.

In this case, to confirm an annotation of the part 101a, a user has to return from an example of screen display 120 to that of 110 by reducing the display and redisplay the balloon 102a. This requires a laborious and time-consuming operation.

Generally a part with large display occupancy (e.g., the part 101e) is usually easy to identify when it is displayed with an enlarged size. However, such part occupies the display screen, precludes a balloon display of other parts (e.g., the part 101a), and may cause the above problem.

Accordingly in this embodiment, new free space is obtained by treating the display area of a part with large display occupancy as free space when a balloon cannot be displayed, for example, by enlarged display. This allows displaying a balloon which cannot be displayed with conventional methods in a display area of the part with large display occupancy.

### <Hardware Configuration of a Display Position Determination Apparatus>

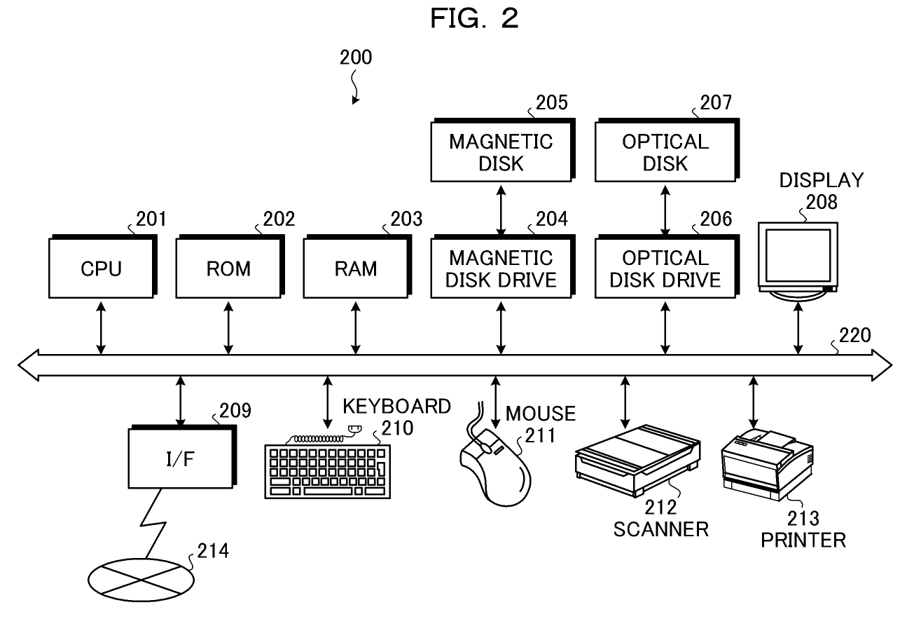

Now, a hardware configuration of a display position determination apparatus according to this embodiment will be explained. FIG. 2 is a block diagram illustrating a hardware configuration of a display position determination apparatus.

In FIG. 2, a display position determination apparatus 200 includes a central processing unit (CPU) 201, a read only memory (ROM) 202, a random access memory (RAM) 203, a magnetic disk drive 204, a magnetic disk 205, an optical disk drive 206, an optical disk 207, a display 208, an interface (I/F) 209, a keyboard 210, a mouse 211, a scanner 212, and a printer 213. Each of the components is connected to a bus 220.

The CPU 201 controls the entire display position determination apparatus. The ROM 202 stores programs such as a boot program. The RAM 203 is used as a work area for the CPU 201. A magnetic disk drive 204 controls reading and writing of data to and from a magnetic disk 205 according to the control by the CPU 201. The magnetic disk 205 stores data written by a control of the magnetic disk drive 204. The magnetic disk 205 may be a hard disk or a flexible disk.

The optical disk drive 206 controls reading and writing data to and from the optical disk 207 according to a control of the CPU 201. The optical disk 207 performs such operations as storing data written by a control of the optical disk drive 206 and making a computer apparatus read data stored in the optical disk 207.

The optical disk 207 may be a compact disk (CD), a digital versatile disk (DVD), a magneto optical disk (MO), or a memory card. The display 208 displays a cursor, an icon, a toolbox, and data including a document, an image, and functional information. The display 208 may be a cathode ray tube (CRT), a thin film transistor (TFT), a liquid crystal display or a plasma display.

The interface 209 is connected to a network 214 such as an internet via a communication line, and is connected to other computer apparatus via the network 214. Then, the I/F 209 controls the network 214 and an internal interface, and input and output of data to and from an external apparatus. The I/F 209 may be a modem and a local area network (LAN) adopter.

The keyboard 210 provides keys to input characters, numbers, and various instructions and performs data input. The keyboard 210 may be a touch-panel input pad, or a numeric keypad. The mouse 211 moves a cursor, selects an area, and moves a window and changes a window size. The mouse 211 may be a trackball or a joystick as long as it provides functions as a pointing device.

A scanner 212 optically reads image data and stores the data in a computer apparatus. The scanner 212 may be an optical character reader (OCR). The printer 213 prints image data and document data. The printer 213 may be a laser printer or an inkjet printer.

### <An Example of Display Screen>

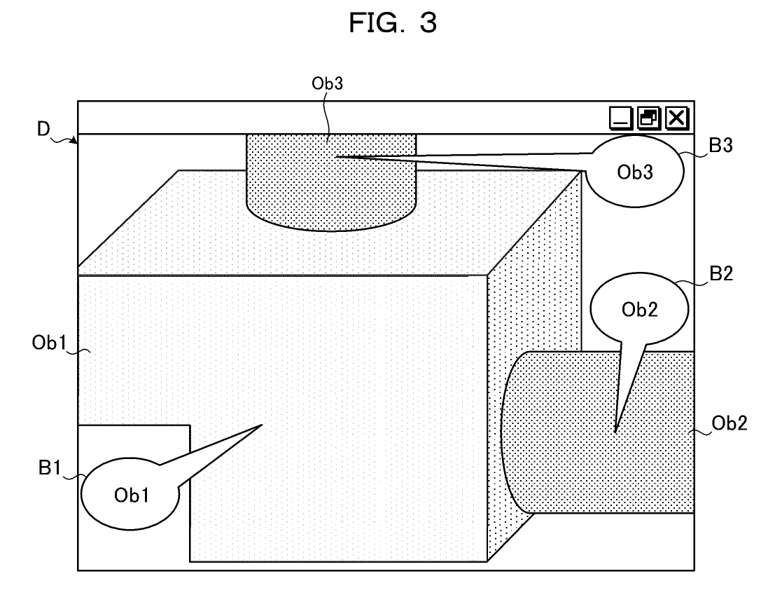

Now, an example of a screen display displayed on the display position determination apparatus 200 is explained. FIG. 3 is an explanatory diagram illustrating an example of a display screen (1 of 3). In FIG. 3, a display screen D displays parts Ob1 to Ob3, and balloons B1 to B3 for each of parts Ob1 to Ob3. Each of balloons B1 to B3 shows a part ID of parts Ob1 to Ob3 respectively as the annotation.

All balloons B1 to B3 are displayed in the area of display screen D where no part is displayed (free space). The display screen D achieves the functions, for example, on the display 208 shown in FIG. 2.

### <A Stored Content of Part Information Table>

Now, a part information table T accessible by the display position determination apparatus 200 shown in FIG. 2 is explained. A case in which the part information table T stores information on parts of the example of display screen D shown in FIG. 3 is explained here.

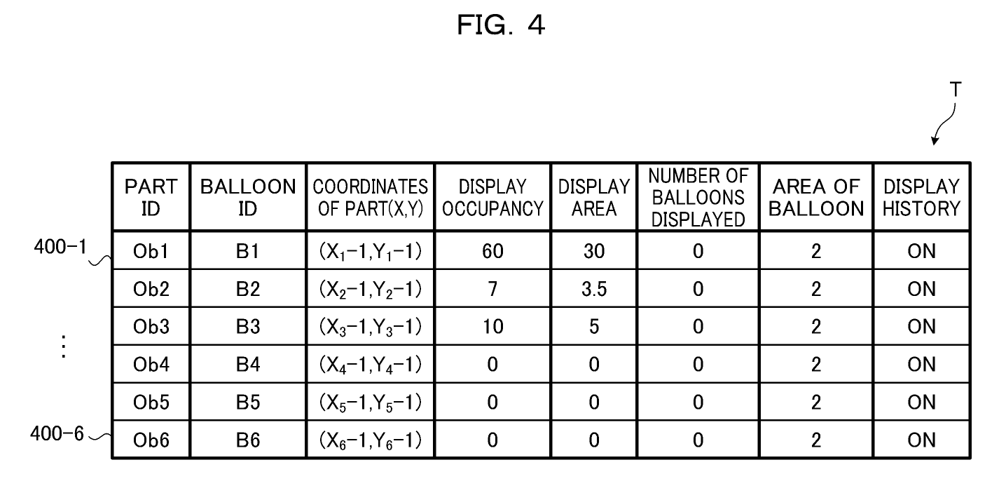

FIG. 4 is an explanatory diagram illustrating an example of a stored content of a part information table (1 of 3). In FIG. 4, a part information table T stores part information 400-1 to 400-6 for each part, including a part ID, a balloon ID, coordinates of a part, display occupancy a display area, the number of balloons displayed, a balloon area, and a display history.

The part ID is an identifier to identify parts Ob1 to Ob6. The balloon ID is an identifier to identify balloons B1 to B6. The coordinates of a part is a coordinate position to identify relative position among parts Ob1 to Ob6. The coordinates of a part here are represented as a coordinate position on a plane of coordinates consisting of X-axis and Y-axis (center coordinates of each of parts Ob1 to Ob6).

The display occupancy is a rate that each of parts Ob1 to Ob6 occupies for total display area in the display screen. The display area is an area in which each of parts Ob1 to Ob6 is displayed. The number of balloons displayed is the number of balloons displayed in the display area for each of parts Ob1 to Ob6. The balloon area is a display area for balloons B1 to B6 for the parts Ob1 to Ob6.

The display history is a flag indicating whether the balloons B1 to B6 have already been displayed or not. If a balloon has already been displayed, the display history is “ON”. If a balloon has not been displayed yet, the display history is “OFF”. For example, the part Ob1, the table shows that the coordinates of the part is “(X1-1, Y1-1)”, the display occupancy is “60” (%), the display area “30” (cm²), the number of balloon displayed is “0”, the display area of balloon B1 is “2” (cm²), and the display history is “ON”.

### <Functional Configuration of Display Position Determination Apparatus>

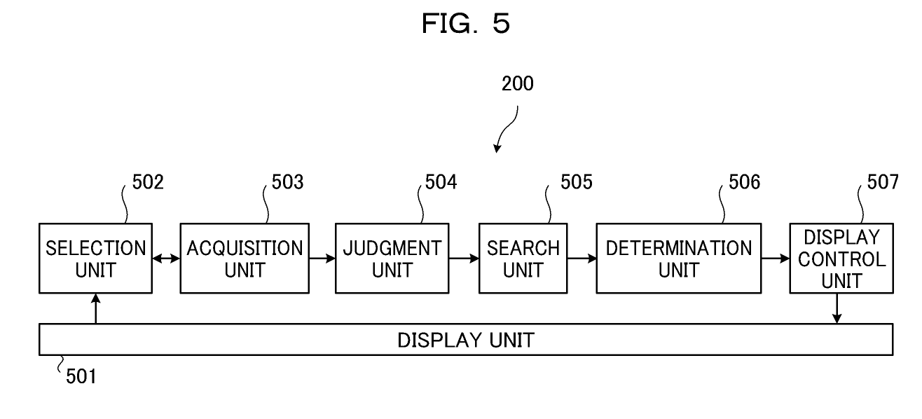

Now, a functional configuration of the display position determination apparatus is explained. FIG. 5 is a block diagram illustrating a functional configuration of a display position determination apparatus. In FIG. 5, a display position determination apparatus 200 provides a display unit 501, a selection unit 502, an acquisition unit 503, a judgment unit 504, a search unit 505, a determination unit 506, and a display control unit 507.

The functions of each of 501 to 507 are achieved by causing a CPU to execute programs for the functions of each of 501 to 507 stored in a storage unit of the display position determination apparatus such as a ROM 302 or RAM 303 or by input/output I/F. Data output by each of functions 501 to 507 is stored in the above storage unit. A connected function to which an arrow points in FIG. 5 reads the data from a connecting function, and causes the CPU to execute a program for the function.

The display unit 501 provides a function to display parts group on a display screen D. The parts are displayed through two-dimensional or three-dimensional data representing shapes, and include display objects comprising a machine such as an electronic appliance, an automobile, or airplane. More specifically the parts may be machine parts such as a screw, a spring, a bolt, and a nut, or electronic parts such as a resistor, a diode, and a transistor.

The selection unit 502 selects a first part from the parts group of display objects. The parts group of display objects includes the parts displayed in a frame of the display screen D, and does not include parts outside the frame. The selection unit 502 may select any part from the parts group by referring to the part information table T, or select a specific part on a priority basis. The method to select a specific part on a priority basis will be explained later.

Selection by the selection unit 502 is processed every time input operations such as enlarged display reduced display or rotational display are accepted. The selection from the parts group is repeated until no unselected parts remain. The input operation is performed by a user operating the keyboard 210 and a mouse 211 shown in FIG. 2.

The acquisition unit 503 acquires display occupancy for the display screen D for each part. The display occupancy is a rate of display area that each part occupies for the entire display screen. More specifically the display occupancy of each of parts Ob1 to Ob3 is acquired, for example, by referring to the part information table T shown in FIG. 4.

The display occupancy of each of parts Ob1 to Ob6 is calculated and stored in the part information table T every time an input operation such as enlargement, reduction, and rotation display is accepted. The calculation processing of display occupancy may be performed by the display position determination apparatus 200, or by an external computer apparatus.

The judgment unit 504 judges whether or not a balloon for the first part selected by the selection unit 502 can be displayed or not in the non-display area where no parts group is displayed in the display screen D. The balloon is a figure for displaying an annotation such as a part name or a part ID. The shape and size of a balloon can be optionally selected.

The specific processing for displaying balloons in free space of the display screen D where no parts group is displayed is a suitable technique. The judgment unit 504 judges whether the balloon for the first part can be allocated to the free space or not by using an suitable allocation algorithm regarding a balloon display and then judges whether the balloon can be displayed or not.

When the judgment unit 504 judges that the balloon cannot be displayed in the non-display area, the search unit 505 searches a second part from the parts group based on the display occupancy acquired by the acquisition unit 503. More specifically a second part with specific display occupancy may be selected from the parts group based on the display occupancy acquired by the acquisition unit 503.

The specific display occupancy is identified by relatively or absolutely evaluating the display occupancy of the parts group. For example, a part with the largest display occupancy may be selected from the parts group, or any part may be selected from a plurality of parts with larger display occupancy from the top.

The search unit 505 may select the second part with display occupancy higher than or equal to a predetermined threshold value. The predetermined threshold value is optionally preset and stored (e.g., more than or equal to 50[%]). When a plurality of parts with display occupancies more than or equal to the predetermined threshold value exist, any part may be selected from the plurality of parts.

The acquisition unit 503 acquires a display position for each part in the display screen D. The display position in the display screen D can be identified, for example, by coordinates of each part. The coordinates of a part can be acquired by referring to the part information table 400.

The search unit 505 searches a second part located within a predetermined area from the display position of the first part from the parts group based on the display position acquired by the acquisition unit 503. The predetermined area is optionally preset and stored in the storage unit. The predetermined area may be set, for example, as a half of the horizontal size of the display screen.

The purpose of searching a second part located within a predetermined area is to display a balloon for the first part in the display area of the second part. If the distance between the first part and the second part is too far, the lead line of the balloon may be too long, which causes deterioration of visibility. Thus, it is desirable that a predetermined area with appropriate distance be set so as not to deteriorate visibility.

A part located within the predetermined area can be identified, for example, by calculating the linear distance between the coordinates of the first part and other part of display objects. When a plurality of parts exists within the predetermined area, a part located nearest to the first part may be searched from a plurality of parts.

The determination unit 506 determines whether the display area of the balloon for the first part is within the display area of the balloon for the second part searched by the search unit 505b. More specifically for example, assuming the display area of the second part is free space and by applying a suitable allocation algorithm, the display area of the balloon for the first part is determined.

When a balloon cannot be displayed in the display area of the second part searched by the search unit 505 (e.g., free space has been decreased because another balloon has already been displayed), another second part may be searched from among the remaining parts excluding those already have been searched.

The display control unit 507 provides functions to control the display unit 501 and display a balloon for the first part within the display area determined by the determination unit 506. This enables display of the balloon for the first part that cannot be displayed in the display area for the second part.

The acquisition unit 503 acquires a display history of a balloon for each part. The display history is information for identifying whether a balloon for a part has been displayed at least once during a series of operations by a user. The display history can be acquired by referring to the part information table T as to display occupancy and display position.

The judgment unit 504 judges whether a balloon for the second part searched by the search unit 505 has been displayed or not based on the display history acquired by the acquisition unit 503. More specifically the judgment unit 504 judges that the balloon has already been displayed when the display history of the second part is “ON”, whereas the balloon has not been displayed yet when the display history of the second part is “OFF”.

The determination unit 506 excludes the display area of the second part from objects to be determined, when the judgment unit 504 judges that the balloon has not been displayed yet. In other words, when the balloon for the second part has already been displayed, the display area of the balloon for the first part is determined to be within the display area of the second part.

In general, a user presumably cannot identify a part, if the balloon for the part has never been displayed. In this case, displaying a balloon for another part in the display area of the part may cause false recognition. Thus, when displaying a balloon of a part for the first time, the balloon for another part is not displayed.

The processing of judgment of display history by the judgment unit 504 may be performed prior to the processing of search by the search unit 505. In this case, parts with balloons which have never been displayed may be excluded from the objects searched by the search unit 505 for the second part. This can prevent the search unit 505 from searching balloons when the judgment unit 504 judges the balloons cannot be displayed in the non-display area.

The judgment unit 504 judges whether a balloon for the first part can be displayed in the display area of the first part or not. More specifically for example, when a balloon for the first part cannot be displayed in the non-display area, whether the balloon can be displayed in the display area of the first part (a part to which the balloon belongs) or not may be judged.

The determination unit 506 determines the display area of the balloon for the first part to be within the display area of the first part, when the judgment unit 504 judges the first part can be displayed in the display area. In this case, the display control unit 507 controls the display unit 501 to display the balloon for the first part in the display area of the first part, because the balloon for the first part cannot be displayed in free space of the display area D.

The selection unit 502 may select a part from the parts group of display objects where the linear distance between a display position of each part and a center of display area D is the shortest. The linear distance between a display position of each part and the center position of the display area D can be calculated from the coordinates of the part and the central coordinate. Then, parts with the display position nearer to the central position of the display area D are given priority in selection. As described above, according to this embodiment, a balloon that cannot be displayed in free space of the display area D is displayed in the display area of a second part with larger display occupancy by assuming the area to be free space.

However, when a display area for a balloon has already been determined to be within the display area of the second part, free space is reduced, and the area may not be determined to be a display area for a new balloon. Generally, a part displayed around the center of the display screen may be important for a user. Accordingly parts located nearer around the center of the display screen may be prioritized in selection, and thereby balloons for the parts that are likely to be important may be prioritized in selection.

When the display area of the balloon for the first part has not been determined yet (the balloon cannot be displayed in free space or a display area where the balloon belongs, or the second part has not been searched yet), the balloon for the first part is not displayed.

The specific processing as to how the above judgment unit 504 judges whether a balloon can be displayed in the display area of the first part or that of the second part will now be explained. First, a stored content of a part information table T updated after enlarging the example of screen shown in FIG. 3 is explained.

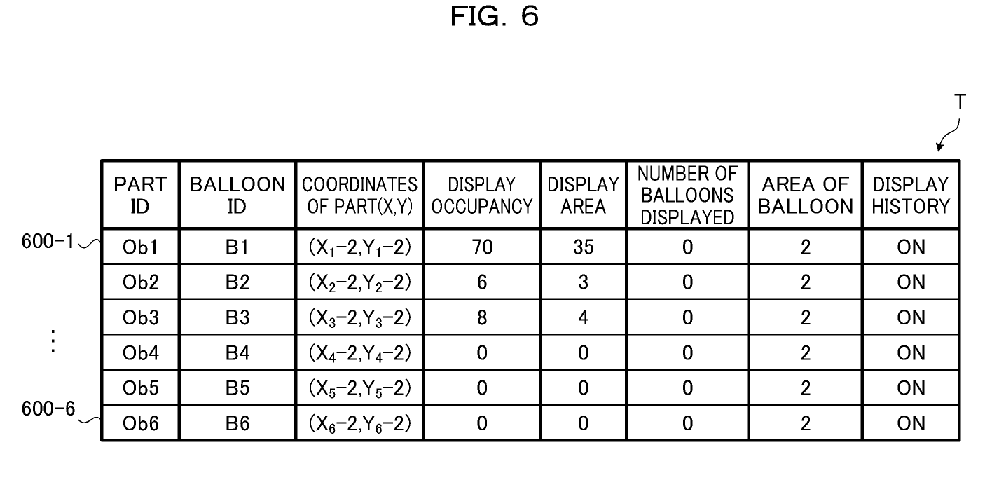

FIG. 6 is an explanatory diagram illustrating an example of a stored content of a part information table (2 of 3). In FIG. 6, the part information table T stores information on parts 600-1 to 600-6 corresponding to each of parts Ob1 to Ob6 respectively. Hereunder, the judgment unit 504 judges whether a balloon can be displayed in the display area of the first part or that of the second part or not based on the stored content of this part information table T.

More specifically, by using an expression (1) below, whether a balloon can be displayed in the display area of a part of display object (the first part or the second part) or not can be judged. In this case, if an inequality of the expression below is satisfied, then it is judged that the balloon can be displayed, whereas if it is not satisfied, it is judged that the balloon cannot be displayed. Note that S1 is a display area of part of a display object; S2 is a display area of all of the balloons displayed in the display area of the part of a display object, and S3 is a display area of a balloon for the part of the display object.

S1−S2>S3 (1)

When display areas of balloons are common to all parts, the S2 in above expression (1) is obtained by multiplying the display area by the number of balloons displayed in the display area of the part of the display object. When display areas of balloons are different among parts, the S2 is obtained by adding display areas of balloons for each of the parts.

Now, taking a part 2 as an example, whether a balloon B2 for the part 2 can be displayed in the display area of the part 2 (the first part) or not is judged. Referring to the part information 600-2 shown in FIG. 6, and applying the following to above expression (1); the display area of part 2, display area of all of balloons (balloon area)×(the number of balloons), and display area of the balloon B2, then the expression below is obtained:

“3−(2×0)>2”

Moreover, using an existing allocation algorithm, an interference check for the part 2 and the balloon B2 is performed. The reason why this check is performed is that even when the display area of the part 2 is large; depending on the shape of the part 2, the balloon B2 cannot be displayed. If the interference check revealed no interference exists, it is judged that the balloon B2 can be displayed in the display area of the part 2.

Now, taking a part 3 as an example, whether a balloon B3 for the part 3 (a first part) can be displayed in the display area of part 1 (the second part) or not is judged. Referring to the part information 600-1 and 600-3 shown in FIG. 6, and applying the following to the above expression (1); the display area of part 1, display area of all of balloons, the number of balloons), and display area of the balloon B3, then the expression below is obtained:

“35−(2×0)>2”

Moreover, using a suitable allocation algorithm, an interference check for the part 1 and the balloon B3 is performed. If the interference check reveals that no interference exists, it is judged that the balloon B3 can be displayed in the display area of the part 1. When the balloon B3 is displayed in the display area of the part 1, the number of balloons displayed in the part information 600-1 is updated from “0” to “1”.

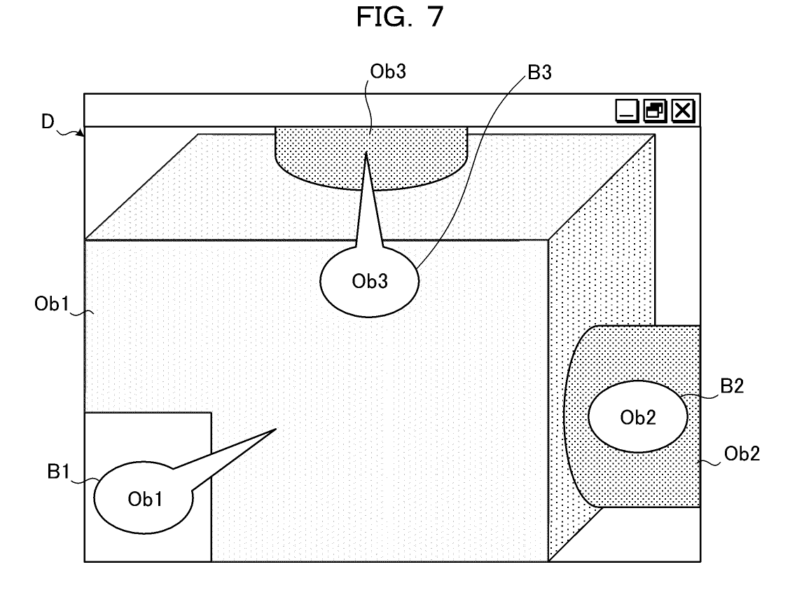

Now, an example of screen which enlarged the screen shown in FIG. 3 is explained. FIG. 7 is an explanatory diagram illustrating an example of a display screen (2 of 3). In FIG. 7, the display screen D displays parts Ob1 to Ob3, and balloons B1 to B3 corresponding to each of the parts Ob1 to Ob3.

More specifically the balloon B1 for the part Ob1 is displayed in a non-display area (free space) in the display screen D where no parts group is displayed. The balloon B2 for the part Ob2 is displayed in the display area of the part Ob2 (the part to which the balloon belongs). The B3 for the part 3 is displayed in the display area of the part 1.

As explained above, even when free space in the display screen D is too small, the balloon B2 and the balloon B3 which are not displayed conventionally can be displayed as follows. The balloon B2 for the part Ob2 can be displayed in the display area of the part Ob2 to which the balloon belongs, and the balloon B3 for the part B3 can be displayed in the display area of the part 1 with large display occupancy (the display occupancy: 70[%]).

Now, an example of a screen in which a balloon for a first part is displayed in a display area of a second part which is within a predetermined area from the display position of the first part is explained. A processing for searching a second part within a predetermined area from the display position of a first part is performed, for example, when a balloon can not be displayed in the display area for the part to which the balloon belongs, and a second part with display occupancy of more than or equal to a predetermined threshold value is not found by the search as well.

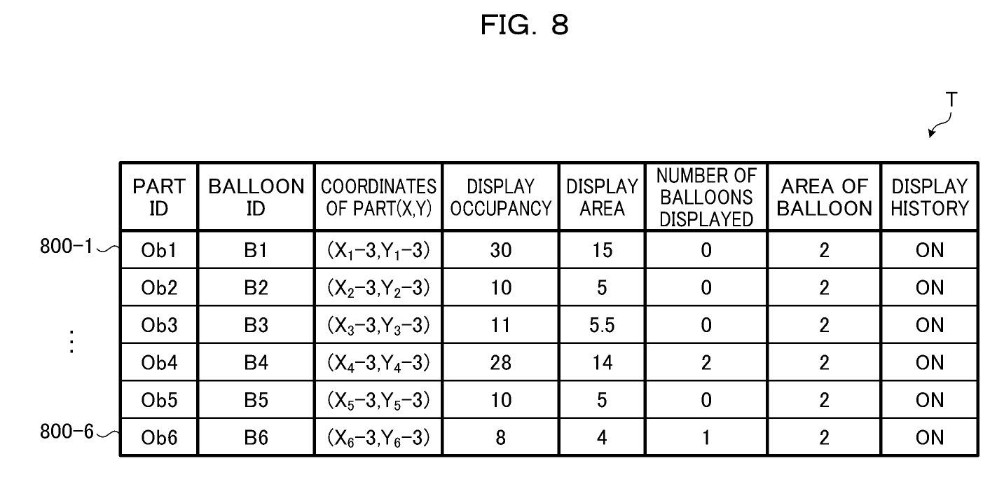

Here, a stored content of a part information table T updated after reducing the example screen shown in FIG. 7 is explained. FIG. 8 is an explanatory diagram illustrating an example of a stored content of a part information table (3 of 3). In FIG. 8, the part information table T stores part information 800-1 to 800-6 corresponding to each of parts Ob1 to Ob6.

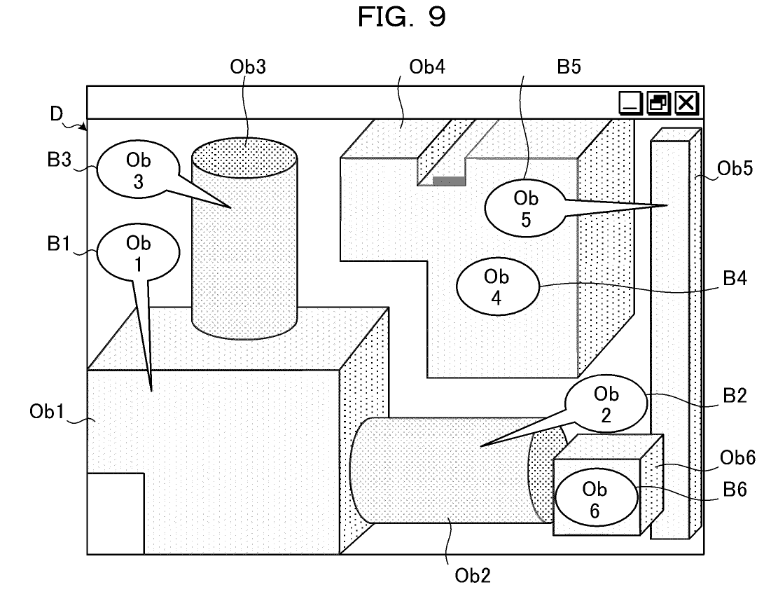

A predetermined threshold value is assumed to be set to “60[%]” here. According to part information 800-1 to 800-6 shown in FIG. 8, a part with display occupancy of more than or equal to the predetermined threshold value does not exist. In this case, an example screen of the display screen D is as shown in FIG. 9.

FIG. 9 is an explanatory diagram illustrating an example of a display screen (3 of 3). In FIG. 9, the display screen D displays parts Ob1 to Ob6 and balloons B1 to B6 corresponding to each of parts Ob1 to Ob6 are displayed as well. More specifically balloons B1 to B3 for parts Ob1 to Ob3 are displayed in a non-display area (free space) in the display screen D where no parts group is displayed.

Moreover, a balloon B4 for the part OB4 and B6 for the part Ob6 are displayed in the display areas of parts to which the balloons belong (parts Ob4 and Ob6) respectively The balloon 5 for the part 5 is displayed in the display area of a part 4 which is located within a predetermined display area from the display position of the part 5. This is because the balloon 5 cannot be displayed in the display area of a part to which the balloon belongs and a part with display occupancy of more than or equal to a predetermined threshold value is not found by the search.

As explained above, even when free space in the display screen D is too small, and no part with display occupancy of more than or equal to a predetermined threshold value exists, the balloon B5 for the part Ob5 which is not conventionally displayed, can be displayed in the display area of the part 4 located within a predetermined area from Ob5.

### <Processing Procedures of Determining Display Position by a Display Position Determination Apparatus>

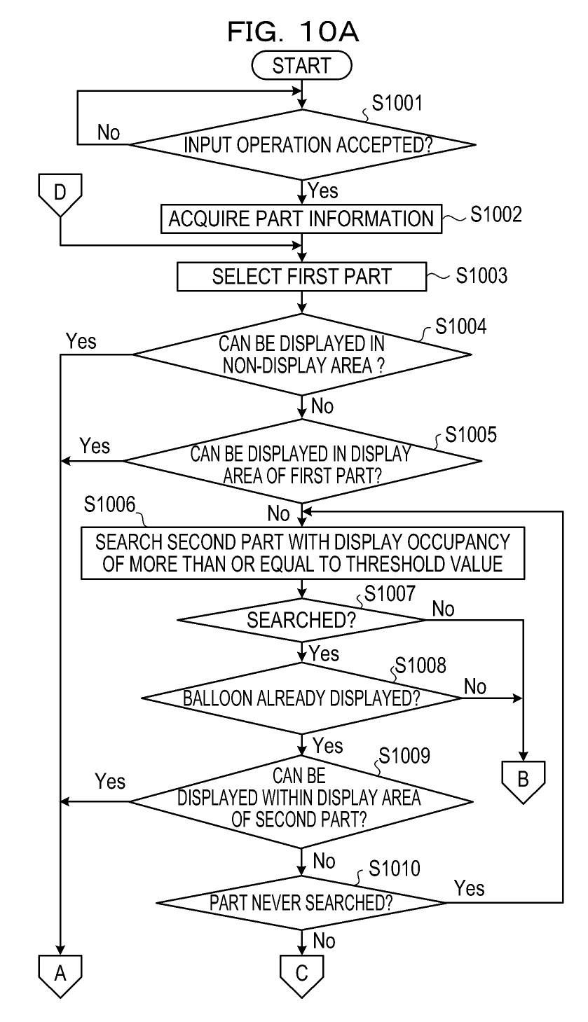

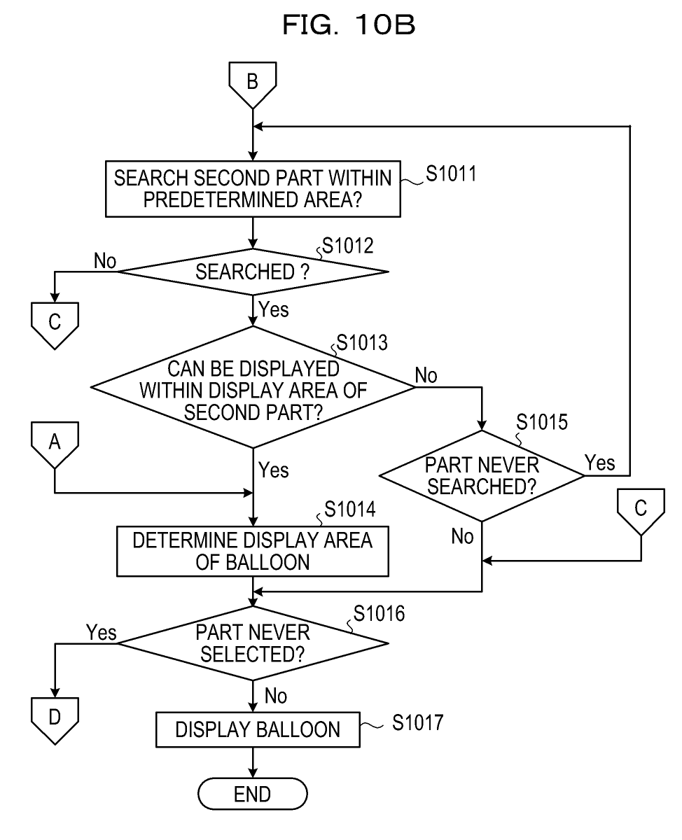

Now, processing procedures of determining a display position by the display position determination apparatus 200 is explained. FIG. 10A and FIG. 10B are flowcharts illustrating examples of processing procedures of the display position determination apparatus for determining a display position. In the flowchart of FIG. 10A, first, it is judged whether input operation for enlarged display reduced display and rotational display for the parts group displayed in the display screen D are accepted or not. (Operation S1001).

Then, waiting for accepting input operation (Operation S1001: No), if accepted (Operation S1001: Yes), an acquisition unit 503 acquires part information for each part from a part information table T (Operation S1002). Then, a selection unit 502 selects a first part from the parts group of display objects (Operation S1003).

Subsequently a judgment unit 504 judges whether a balloon for the first part selected by a selection unit 502 can be displayed or not in a non-display area of the display screen D where no parts group is displayed (Operation S1004). If it is judged that the balloon can be displayed in the non-display area (Operation S1004: Yes), the processing proceeds to the operation S1014 shown in FIG. 10B. Then, a determination unit 506 determines the display area of the balloon for the first part to be within the non-display area (Operation S1014).

When it is judged that the balloon for the first part cannot be displayed in the non-display area at Operation S1004 (Operation S1004: No), the judgment unit 504 judges whether the balloon for the first part can be displayed in the display area of the first part or not based on the part information acquired by the acquisition unit 503 (Operation S1005).

If it is judged that the balloon can be displayed in the display area of the first part (Step S1005: Yes), the processing proceeds to Operation S1014 shown in FIG. 10B. Then the determination unit 506 determines the display area of the balloon for the first part to be within the display areas of the first part (Operation S1014).

If it is judged that the balloon cannot be displayed within the display area of the first part (Operation S1005: No), a second part with display occupancy of more than or equal to a predetermined threshold value is searched from the parts group based on the part information acquired by the acquisition unit 503 (Operation S1006).

If the second part with display occupancy of more than or equal to a predetermined threshold value is searched (Operation S1007: Yes), it is judged whether the balloon for the second part searched at Operation S1006 has already been displayed or not based on the part information acquired by the acquisition unit 503 (Operation S1008).

If it is judged that the balloon for the second part has already been displayed (Operation S1008: Yes), the judgment unit 504 judges whether the balloon for the first part can be displayed within the display area of the second part or not based on the part information acquired by the acquisition unit 503 (Operation S1009).

If it is judged that the balloon for the second part can be displayed within the display area of the second part (Operation S1009: Yes), the processing proceeds to Operation S1014 shown in FIG. 10B. Then the determination unit 506 determines the display area of the balloon for the first part to be within the display area of the second part searched at Operation S1006 (Operation S1014).

If it is judged that the balloon cannot be displayed within the display area of the second part at Operation S1009 (Operation S1009: No), it is judged whether any part with display occupancy of more than or equal to a predetermined threshold value that has never been searched exists or not (Operation S1010). If such part exists (Operation S1010: Yes), the processing returns to Operation S1006, and a second part with display occupancy of more than or equal to a predetermined threshold value is searched from parts which have never been searched.

If parts which have never been searched do not exist (Operation S1010: No), the processing proceeds to Operation S1016 shown in FIG. 10B.

If no second part with display occupancy of more than or equal to a predetermined threshold value is not found by the search at Operation S1007 (Operation S1007: No), or it is judged that the balloon for the second part have not been displayed yet (Operation S1008: No), the processing proceeds to the Operation S1011 shown FIG. 10B. Then the search unit 505 searches a second part located within a predetermined area from the display position of the first part based on the part information acquired by the acquisition unit 503 (Operation S1011).

If a second part located within a predetermined area from the display position of the first part was not found by the search (Operation S1012: No), the processing proceeds to Operation S1016.

If a second part located within a predetermined area from the display position of the first part is searched (Operation S1012: Yes), the judgment unit 504 judges whether the balloon for the first part can be displayed within the display area of the second part searched at Operation S1011 based on the part information acquired by the acquisition unit 503 (Operation S1013).

If it is judged that the balloon can be displayed within the display area of the second part (Operation S1013: Yes), the determination unit 506 determines the display area of the balloon for the first part to be within the display area of the second part searched at Operation S1011 (Operation S1014).

Subsequently it is judged whether parts which have never been selected exist or not in the parts group (Operation S1016: Yes). If parts which have never been selected exist (Operation S1016: Yes), the processing returns to S1003 shown in FIG. 10A, and the series of processing is repeated.

If it is judged that the balloon cannot be displayed within the display area of the second part in Operation S1013 (Operation S1013: No), it is judged whether any part is located within a predetermined area from the display position of the first part and that has never been searched exists or not (Operation S1015).

If parts that have never been searched exist (Operation S1015: Yes), the processing returns to Operation S1011. Then, a second part located within a predetermined area from the display position of the first part is searched from parts which have never been searched. If parts which have never been searched do not exist (Operation S1015: No), the processing proceeds to Operation S1016.

If parts which have never been selected do not exist at Operation S1016 (Operation S1016: No), the display control unit 507 controls the display unit 501 and displays the balloon for the first part in the display screen D based on the determination result by the determination unit 506 (Operation S1017). Then the processing of this flow chart is completed.

As explained above, according to this embodiment, when free space in the display screen D is too small to display the balloon, a display area of the second part with specific display occupancy can be assumed to be free space. Thus, even when free space in the display screen D is too small, the balloon for the first part can be displayed within the display area of the second part with specific display occupancy.

If parts with specific display occupancy do not exist, the display area of the second part which is located within a predetermined area from the display position of the first part can be assumed to be new free space. Thus, even when parts with specific display occupancy do not exist, the balloon for the first part can be displayed within the display area of the second part located within a predetermined area from the display position of the first part.

As explained above, according to this display position determination apparatus and method thereof, even when free space in the display screen D is too small, the balloon can be displayed at an appropriate display position. Thus, the present invention has an effect to reduce both operation burden and hours.

The display position determination method explained in this embodiment can be achieved by causing a computer such as a personal computer and a workstation to execute a prepared program. Such program is stored in a computer-readable storage medium such as a hard disk, a flexible disk, compact disc ROM (CD-ROM), magneto-optical (MO) disk, and digital versatile disk (DVD), and executed by a computer. The program may be transmission medium distributable through a network such as Internet.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of one embodiment of the invention over another. Although the embodiment of the present invention has been described in detail, it should be understood that the various changes, substitutions, and alterations could be made hereto without departing from the spirit and scope of the invention.

What is claimed is:

1. A computer-readable storage medium storing a program for determining a display position of a balloon that shows an annotation of each of parts in the display the program causing a computer to execute a process comprising:
a step of selecting a first part from a parts group of display objects;
a step of acquiring display occupancy for a display screen for each of said parts;
a step of judging whether a balloon for the first part selected by said step of selecting can be displayed or not in a non-display area where no said display objects is displayed in said display screen;
a step of searching a second part from said parts group based on the display occupancy acquired by said step of acquiring when said step of judging judges that the balloon cannot be displayed in said non-display area; and
a step of determining the display area of the balloon for said first part to be within the display area of the second part searched by said step of searching.

2. A computer-readable storage medium according to claim 1, wherein said step of searching searches a second part with specific display occupancy from said parts group based on the display occupancy acquired by said step of acquiring.

3. A computer-readable storage medium according to claim 2, wherein said step of searching searches a second part with display occupancy acquired by said step of acquiring that is more than or equal to a predetermined threshold display occupancy value.

4. A computer-readable storage medium according to claim 1, wherein said step of acquiring further acquires a display position on said display screen for each of said parts; and
said step of searching searches said parts group for a second part located within a predetermined area from the display position of said first part based on the display position acquired by said step of acquiring.

5. A computer-readable storage medium according to claim 1, wherein said step of acquiring further acquires a display history of balloons for each of said parts;
said step of judging judges whether the balloon for the second part searched by said step of searching has already been displayed or not based on the display history acquired by said step of acquiring; and
said step of determining excludes the display area of said second part from objects to be determined when said step of judging judges that the balloon for said second part has not been displayed yet.

6. A computer-readable storage medium according to claim 1, wherein said process further comprising:
a step of second judging which judges whether the balloon for the first part can be displayed in the display area of said first part or not when said step of first judging judges that the balloon cannot be displayed in said non-display area; and
said step of determining determines that the display area of the first part is within the display area of the balloon for said first part when said step of second judging judges that the balloon for said first part can be displayed in the display area of said first part.

7. A computer-readable storage medium according to claim 1, wherein said step of determining determines that the display area of the balloon for said first part is within said non-display area when said step of judging judges that the balloon can be displayed in said non-display area.

8. A computer-readable storage medium storing a display position determination program according to claim 1, wherein said step of selecting selects a part from said parts group of display objects such that a linear distance between the display position of the part and a center position of said display area is shortest.

9. A display position determination apparatus comprising:
a selection unit selecting a first part from a parts group of display objects;
an acquisition unit acquiring display occupancy in a display screen for each of said parts;
a judgment unit judging whether the balloon for the first part selected by said selection unit can be displayed within a non-display area or not in said display screen where no parts group is displayed;
a search unit searching a second part from said parts group based on the display occupancy acquired by said acquisition unit when said judgment unit judges that the balloon cannot be displayed in said non-display area; and
a determination unit determining that the display area of the balloon for said first part is within the display area of the second part searched by said search unit.

10. A display position determination method wherein a display position determination apparatus performs operations of:
selecting a first part from a parts group of display objects;
acquiring display occupancy in a display screen for each of said parts;
judging whether a balloon for the first part can be displayed within a non-display area where no display objects are displayed in said display screen;
searching a second part from said parts group based on the display occupancy acquired by said acquiring when said judging judges that the balloon cannot be displayed in said non-display area; and
determining the display area of the balloon for said first part to be within the display area of the second part searched by said searching.
